(19) United States
(12) Patent Application Publication
(10) Pub. No.: US 2021/0306410 A1
(43) Pub. Date: Sep. 30, 2021

(54) MONITORING SYSTEM AND COMPUTER-READABLE RECORDING MEDIAUM

(71) Applicant: FUJITSU LIMITED, Kawasaki-shi (JP)

(72) Inventor: Shingo OKUNO, Kawasaki (JP)

(73) Assignee: FUJITSU LIMITED, Kawasaki-shi (JP)

(21) Appl. No.: 17/164,865

(22) Filed: Feb. 2, 2021

(30) Foreign Application Priority Data
Mar. 31, 2020 (JP) 2020-063362

(51) Int. Cl. H04L 29/08

(52) U.S. Cl. CPC H04L 67/1002; H04L 67/1095

(57) ABSTRACT

A monitoring system includes: a plurality of terminal devices; a plurality of execution servers configured to execute requests received from the terminal devices; and a monitoring server, the plurality of execution servers each operate as a leader server or a follower server in a first distribution method, the first distribution method and a second distribution method are able to be executed, in the first distribution method, the plurality of terminal devices transmit all read requests and all write requests to the leader server and the leader server executes execution result copying in which results of execution of the write requests are copied to the follower server, and in the second distribution method, the plurality of terminal devices transmit the write requests to all the plurality of execution servers and transmit the read requests to one of the plurality of execution servers.

### CROSS-REFERENCE TO RELATED APPLICATION

This application is based upon and claims the benefit of priority of the prior Japanese Patent Application No. 2020-63362, filed on Mar. 31, 2020, the entire contents of which are incorporated herein by reference.

### FIELD

The embodiments discussed herein are related to a monitoring system and computer-readable recording media.

### BACKGROUND

For example, in a system in which safety is important such as a system for a bank, in order to safely operate the system even when one or some of devices fail, a distribution system which includes a plurality of servers and in which states are replicated between the servers may be employed. In the distribution system, sequences of processing instructions are synchronized between servers, and processing processes are multiplexed.

Techniques related to the distribution systems are described in Japanese Laid-open Patent Publication Nos. 2014-222451, 2006-235736, and 2017-147659.

### SUMMARY

According to an aspect of the embodiments, a monitoring system includes: a plurality of terminal devices; a plurality of execution servers configured to execute requests received from the terminal devices; and a monitoring server, the plurality of execution servers each operate as a leader server or a follower server in a first distribution method, the first distribution method and a second distribution method are able to be executed, in the first distribution method, the plurality of terminal devices transmit ail read requests and all write requests to the leader server and the leader server executes execution result copying in which results of execution of the write requests are copied to the follower server, and in the second distribution method, the plurality of terminal devices transmit the write requests to all the plurality of execution servers and transmit the read requests to one of the plurality of execution servers, and the monitoring server includes a processor configured to cause the plurality of terminal devices and the plurality of execution servers to execute the first distribution method, cause the plurality of terminal devices and the plurality of execution servers to execute the second distribution method, monitor a load of the plurality of execution servers, and select one of the first distribution method and the second distribution method in accordance with the load and execute the selected one of the first distribution method or the second distribution method.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a communication system;

FIG. 2 is a diagram illustrating a configuration example of a monitoring server;

FIG. 3 is a diagram illustrating a configuration example of a server;

FIG. 4 is a diagram illustrating a configuration example of a terminal device;

FIG. 5 is a diagram illustrating an example of processing of a first method;

FIG. 6 is a diagram illustrating an example of processing of a second method;

FIG. 7 is a diagram illustrating an example of a process flowchart of a distribution method switching process;

FIG. 8 is a diagram illustrating an example of a process flowchart of a load monitoring process;

FIG. 9 is a diagram illustrating an example of a sequence of a switching process to the first method;

FIG. 10 is a diagram illustrating examples of message queues of servers at timing of switching to the first method;

FIG. 11 is a diagram illustrating an example of a process flowchart of a first method switching follower process;

FIG. 12 is a diagram illustrating an example of a process flowchart of a first method switching leader process;

FIG. 13 is a diagram illustrating an example of a process flowchart of a first method switching terminal process;

FIG. 14 is a diagram illustrating an example of a sequence of a switching process to the second method;

FIGS. 15A and 15B are diagrams illustrating examples of the message queues of the servers at timing of switching to the second method and after switching to the second method;

FIG. 16 is a diagram illustrating an example of a process flowchart of a second method switching follower process;

FIG. 17 is a diagram illustrating an example of a process flowchart of a second method switching leader process; and

FIG. 18 is a diagram illustrating an example of a process flowchart of a second method switching terminal process.

### DESCRIPTION OF EMBODIMENTS

As a distribution system, there is a passive replication system that includes a leader server which executes processing processes and follower servers other than the leader server. The passive replication system operates a passive replication method. In the passive replication system, the leader server receives read requests and write requests from clients and executes corresponding processing processes. The leader server copies the results the execution of the write requests to each of the follower servers.

Also, as a distribution system, there is an active replication system that includes a plurality of parallel servers. The active replication system operates an active replication method. In the active replication system, write requests are executed by all the servers, and read requests are distributed to the servers.

In the active replication method, sequences of execution of the requests of the servers are usually synchronized among all the servers. In the distribution system, for example, broadcast (atomic broadcast) to ensure that messages received by all normal servers and the sequences of the reception of the messages are equivalent is performed and the sequences of the execution of the requests are synchronized.

However, in the passive replication system, the leader server executes all the read requests and copies the results of the execution of the write requests to the follower servers. Thus, a response time period from transmission of a request from the client to return of the result to the client may be increased. In the active replication system, although the read requests are balanced, a transmission cost may increase due to the execution of the atomic broadcast, and a response time period may be increased.

Accordingly, a disclosure provides a monitoring system, a monitoring program, and a program to be monitored that suppress an increase in response time period in a distributed system.

### First Embodiment

A first embodiment will be described.

### Configuration Example of Communication System

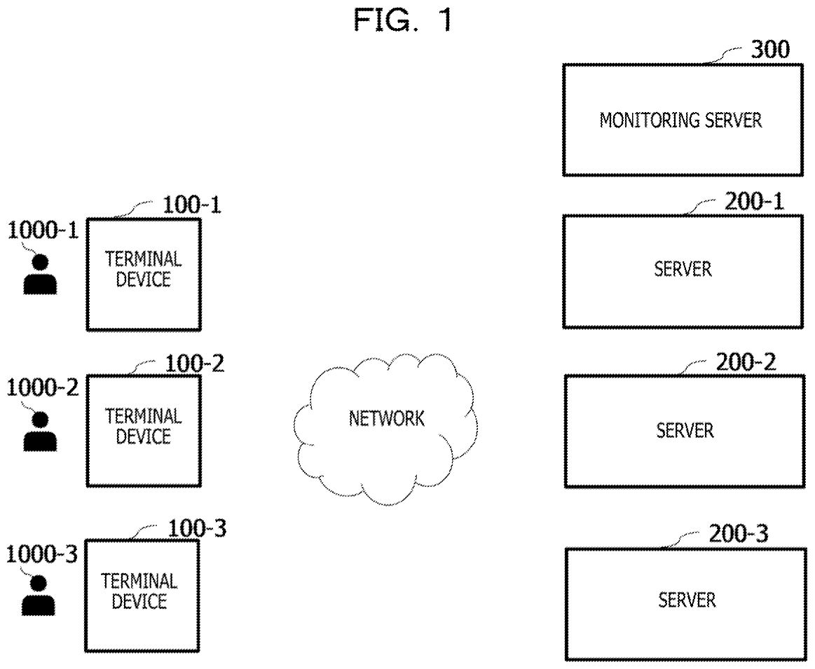

FIG. 1 is a diagram illustrating a configuration example of a communication system 10. The communication system 10 includes terminal devices 100-1 to 100-3, servers 200-1 to 200-3, a monitoring server 300, and a network 400. The communication system 10 is a monitoring system in which the monitoring server monitors load. In the system, a distribution process of a first method or a second method is executed in accordance with the load. Details of the first method and the second method will be described later.

The devices in the communication system 10 communicate with each other via the network 400. In FIG. 1, although only a network included in the communication system 10 is the network 400, for example, the communication system 10 may include a local network that relays communication between the monitoring server 300 and the servers 200-1 to 200-3. In the communication system 10, the structure of the network may be in any form as long as communication between the devices is able to be executed.

The terminal devices 100-1 to 100-3 (hereinafter, may also be referred to as “terminal devices 100”) are terminal devices operated by client users 1000-1 to 1000-3 (hereinafter, may also be referred to as “clients 1000”). For example, the terminal devices 100 are smartphones or computer machines. The terminal devices 100 transmit read requests and write requests to the servers 200-1 to 200-3 in accordance with operations of the client users 1000. In FIG. 1, although the communication system 10 includes three terminal devices 100, the communication system 10 may include two or less terminal devices, or four or more terminal devices.

The servers 200-1 to 200-3 (hereinafter, may also be referred to as “servers 200”) are server machines that receive read requests and write requests from the terminal devices 100 and execute corresponding processes. The servers 200 execute different processes in the distribution process of the first method and the distribution process of the second method. The servers 200 execute the distribution process of the first method or the second method in accordance with instructions from the monitoring server 300.

The monitoring server 300 is a server machine that monitors load in the communication system 10 and determines whether the distribution process of the first method or the distribution process of the second method is to be executed. The monitoring server 300 instructs the terminal devices 100 and the servers 200 which of the distribution processes is to be executed.

### Configuration Example of Monitoring Server 300

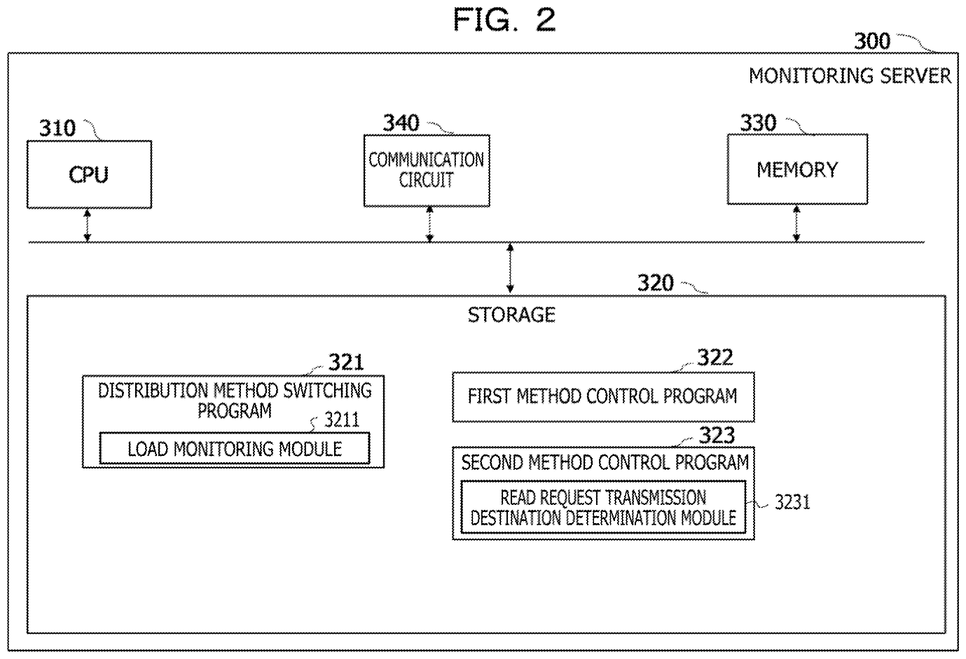

FIG. 2 is a diagram illustrating a configuration example of the monitoring server 300. The monitoring server 300 includes a central processing unit (CPU) 310, a storage 320, a memory 330, and a communication circuit 340.

The storage 320 is an auxiliary storage device, such as a flash memory, a hard disk drive (HDD), or a solid-state drive (SSD), for storing programs and data. The storage 320 stores a distribution method switching program 321, a first method control program 322, and a second method control program 323.

The memory 330 is a space into which the programs stored in the storage 320 are loaded. The memory 330 may also be used as a space in which the programs store data.

The communication circuit 340 is a circuit that is coupled to the other devices in order to communicate with the other devices. The communication circuit 340 is, for example, a network interface card, a communication port, or the like.

The CPU 310 is a processor that loads the programs stored in the storage 320 into the memory 330 and executes the loaded programs to construct units and to achieve processes.

The CPU 310 executes the distribution method switching program 321 to construct a monitoring unit and a switching unit and execute a distribution method switching process. The distribution method switching process is a process that monitors the load in the communication system 10 and switches a distribution method in accordance with the load.

The CPU 310 executes a load monitoring module 3211 included in the distribution method switching program 321 to construct the monitoring unit and execute a load monitoring process. The load monitoring process is a process that monitors (measures) the load in the communication system 10.

The CPU 310 executes the first method control program 322 to construct a first control unit and execute a first method control process. The first method control process is a process that controls the first method executed by the servers 200 and the terminal devices 100.

The CPU 310 executes the second method control program 323 to construct a second control unit and execute a second method control process. The second method control process is a process that controls the first method executed by the servers 200 and the terminal devices 100. In the second method control process, the monitoring server 300 determines the servers 200 to which the terminal devices 100 transmit read requests.

The CPU 310 executes a read request transmission destination determination module 3231 included in the second method control program 323 to construct a transmission destination instruction unit and execute a read request transmission destination determination process. In the read request transmission destination determination process, for example, the terminal devices 100 determine the servers 200 to which the read requests are transmitted so that the number of the received read requests is balanced among the servers 200.

### Configuration Example of the Servers 200

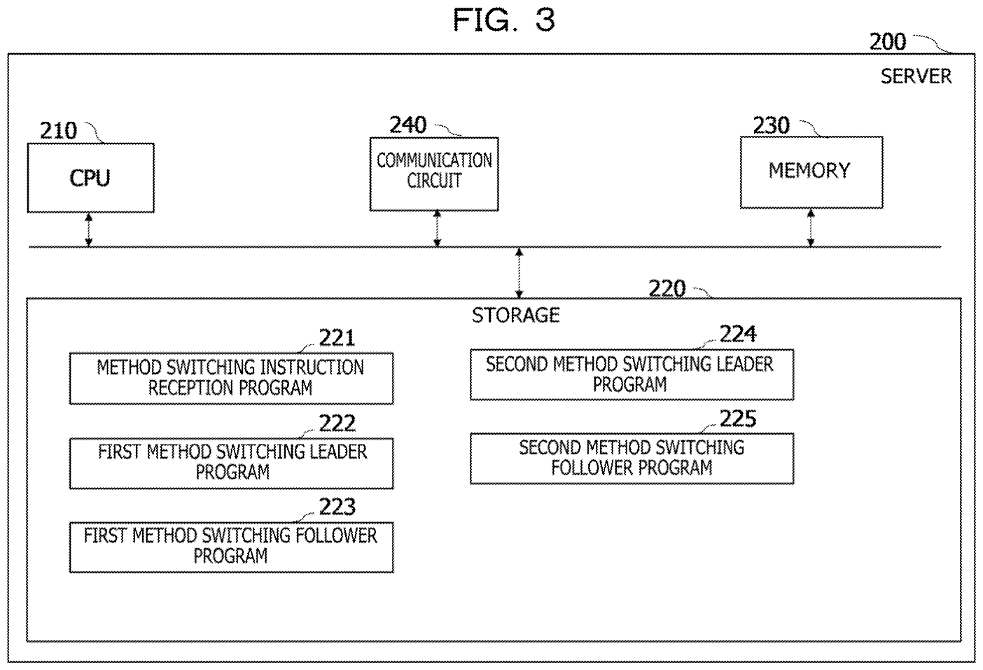

FIG. 3 is a diagram illustrating a configuration example of each of the servers 200. The server 200 includes a CPU 210, a storage 220, a memory 230, and a communication circuit 240.

The storage 220 is an auxiliary storage device, such as a flash memory, an HDD, or an SSD, for storing programs and data. The storage 220 stores a method switching instruction reception program 221, a first method switching leader program 222, a first method switching follower program 223, a second method switching leader program 224, and a second method switching follower program 225.

The memory 230 is a space into which programs stored in the storage 220 are loaded. The memory 230 may also be used as a space in which the programs store data.

The communication circuit 240 is a circuit that is coupled to the other devices in order to communicate with the other devices. The communication circuit 240 is, for example, a network interface card, a communication port, or the like.

The CPU 210 is a processor that loads the programs stored in the storage 220 into the memory 230 and executes the loaded programs to construct units and to achieve processes.

The CPU 210 executes the method switching instruction reception program 221 to execute a method switching instruction reception process. The method switching instruction reception process is a process executed when a first method switching instruction or a second method switching instruction is received from the monitoring server 300. The server 200 selects and executes a method switching process based on whether the servers 200 itself is a leader server while operating in the first method and whether a switching instruction received from the monitoring server 300 is the first method switching instruction or the second method switching instruction.

The CPU 210 executes the first method switching leader program 222 to execute a first method switching leader process. The first method switching leader process is a process executed when the leader server in the first method receives the first method switching instruction. After executing the first method switching leader process, the server 200 operates as the leader server of the first method.

The CPU 210 executes the first method switching follower program 223 to execute a first method switching follower process. The first method switching follower process is a process executed when a follower server in the first method receives the first method switching instruction. After executing the first method switching follower process, the server 200 operates as the follower server of the first method.

The CPU 210 executes the second method switching leader program 224 to execute a second method switching leader process. The second method switching leader process is a process executed when the leader server in the first method receives the second method switching instruction. After executing the second method switching leader process, the server 200 operates as the server of the second method.

The CPU 210 executes the second method switching follower program 225 to execute a second method switching follower process. The second method switching follower process is a process executed when the follower server in the first method receives the second method switching instruction. After executing the second method switching follower process, the server 200 operates as the server of the second method.

When the server 200 is fixedly determined to be the leader server or the follower server in advance, it is sufficient that the server 200 store a program for a corresponding switching process, and the server 200 does not necessarily store a program of another switching process.

### Configuration Example of the Terminal Devices 100

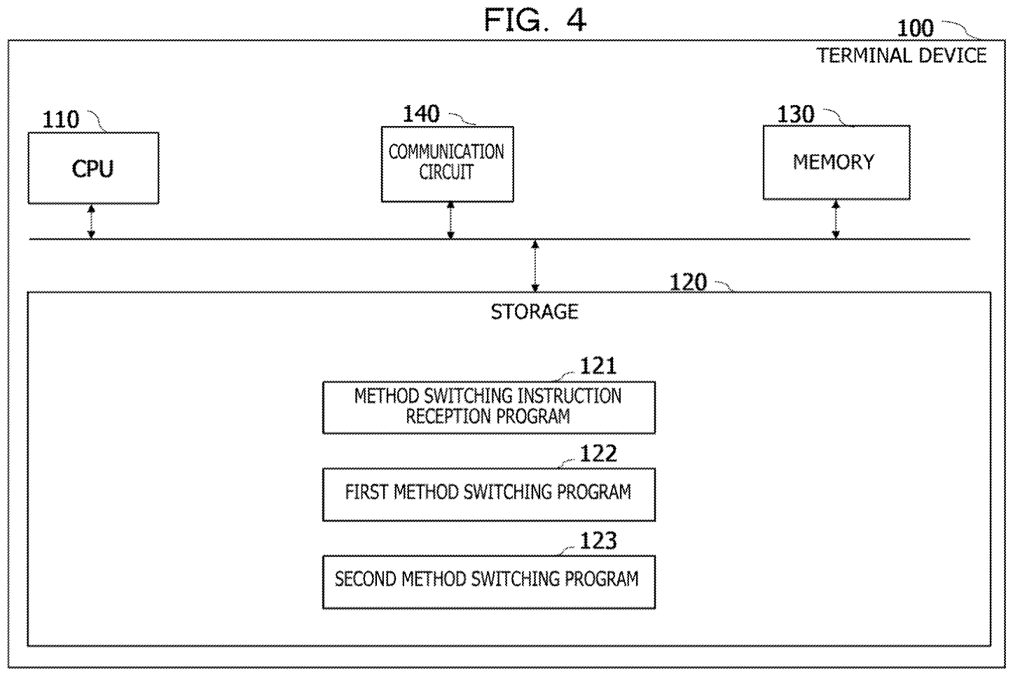

FIG. 4 is a diagram illustrating a configuration example of each of the terminal devices 100. The terminal device 100 includes a CPU 110, a storage 120, a memory 130, and a communication circuit 140.

The storage 120 is an auxiliary storage device, such as a flash memory, an HDD, or an SSD, for storing programs and data. The storage 120 stores a method switching instruction reception program 121, a first method switching program 122, and a second method switching program 123.

The memory 130 is a space into which a program stored in the storage 120 is loaded. The memory 230 may also be used as a space in which the programs store data.

The communication circuit 140 is a circuit that is coupled to the other devices in order to communicate with the other devices. The communication circuit 140 is, for example, a network interface card, a communication port, or the like.

The CPU 110 is a processor that loads the programs stored in the storage 120 into the memory 130 and executes the loaded programs to construct units and to achieve processes.

The CPU 110 executes the method switching instruction reception program 121 to execute the method switching instruction reception process. The method switching instruction reception process is a process executed when the first method switching instruction or the second method switching instruction is received from the monitoring server 300. The terminal device 100 selects and executes a first method switching terminal process or a second method switching terminal process based on whether the switching instruction received from the monitoring server 300 is the first method switching instruction or the second method switching instruction.

The CPU 110 executes the first method switching program 122 to execute the first method switching terminal process. The first method switching terminal process is a process executed when the terminal device 100 receives the first method switching instruction. After executing the first method switching terminal process, the terminal device 100 operates as the terminal device 100 of the first method.

The CPU 110 executes the second method switching program 123 to execute the second method switching terminal process. The second method switching terminal process is a process executed when the terminal device 100 receives the second method switching instruction. After executing the second method switching terminal process, the terminal device 100 operates as the terminal device 100 of the second method.

### About Distribution Method

As the distribution method, one of two methods, the first method and the second method, is selected. Each of the methods will be described below.

### 1. First Method

The first method (first distribution method) is a distribution process configured by using the leader server 200-1 that executes processing processes and the follower servers 200-2 and 200-3 other than the leader server 200-1. In the first method, the leader server 200-1 receives all the read requests and the write requests from the terminal devices 100 and executes corresponding processing processes. The leader server 200-1 copies the results of the execution of the write requests to the follower servers 200-2 and 200-3. For example, the read request according to the first embodiment requests to read certain data and notify of a result of the reading, and the write request is a request that is other than the read request and that requests to execute a certain process. The write request may be, for example, a request to notify of an execution result (success, failure, or the like) in addition to the request for the process.

In the first method, for example, when the leader server 200-1 fails, the server 200-2 changes its role from follower to leader and executes the subsequent processing as the leader server. Thus, execution of the requests from the terminal devices 100 may be continued.

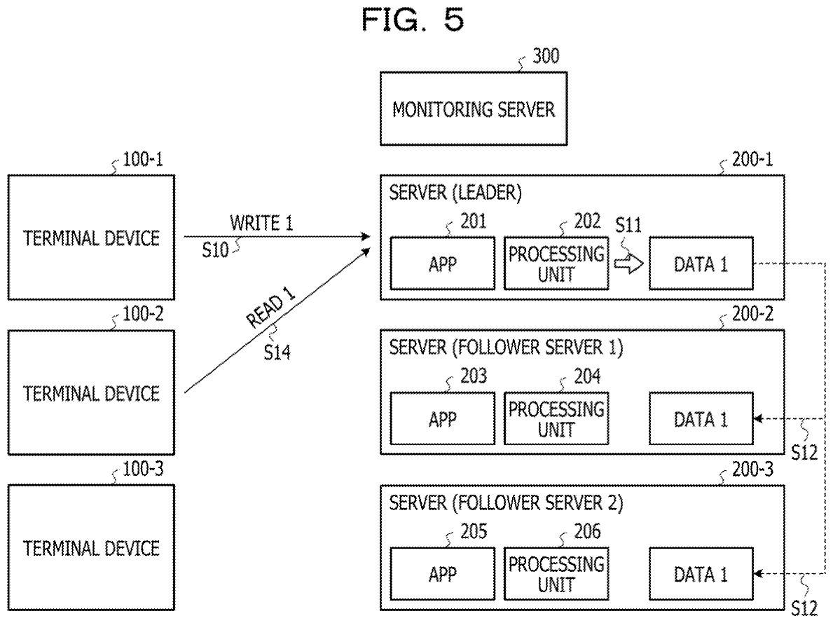

FIG. 5 is a diagram illustrating an example of processing of the first method. The terminal device 100-1 transmits Write 1 that is a write request to the leader server 200-1 (S10).

In the leader server 200-1, upon reception of Write 1 by a corresponding application program (hereinafter, APP) 201, a processing unit 202 executes a process corresponding to Write 1 (S11) and generates Data 1 as a processing result. The leader server 200-1 requests the follower servers 200-2 and 200-3 to copy the Data 1 (S12, S13).

The follower servers 200-2 and 200-3 respond to the copy request and copy the Data 1 to their internal memories or their storages.

The terminal device 100-2 transmits Read 1 that is a read request to the leader server 200-1 (S14).

Upon reception of Read 1 by the corresponding APP 201, the leader server 200-1 reads the Data 1 and transmits the Data 1 to the terminal device 100-2.

As described above, in the first method, the leader server 200-1 receives all the read requests and write requests and executes the processes. The first method is, for example, a passive replication method.

### 2. Second Method

The second method (second distribution method) is a distribution process that is configured with a plurality of parallel servers, executes the write request on all the servers, and distributes execution of the read request to each of the servers. In the second method, for example, even when one of the servers 200 fails, the other servers 200 executes processing in parallel. Thus, the execution of the requests from the terminal devices 100 may be continued.

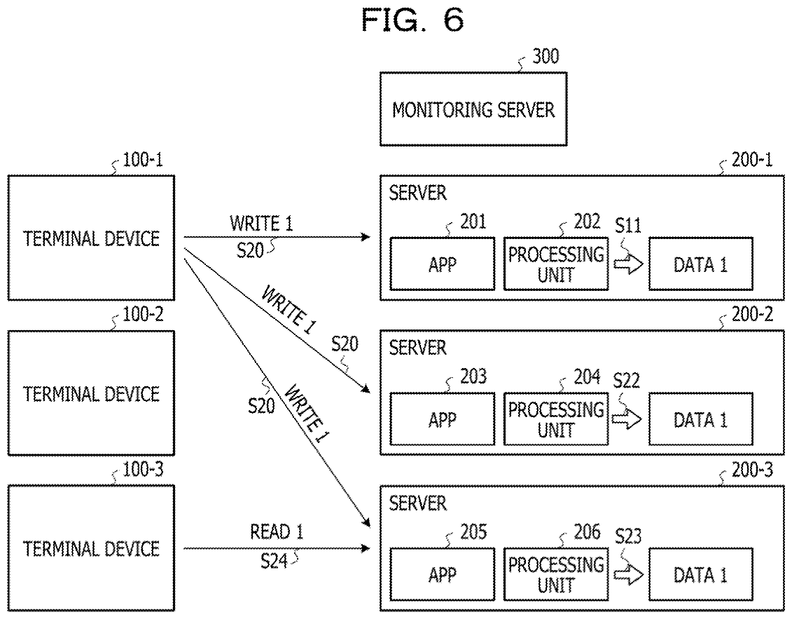

FIG. 6 is a diagram illustrating an example of processing of the second method. The terminal device 100-1 transmits Write 1 to all the servers 200-1 to 200-3 (S20).

In the server 200-1, upon reception of Write 1 by the corresponding APP 201, the processing unit 202 executes the process corresponding to Write 1 (S21) and generates the Data 1 as the processing result. Likewise, in the server 200-2, upon reception of Write 1 by a corresponding APP 203, a processing unit 204 executes the process corresponding to Write 1 (S22) and generates the Data 1 as the processing result. Likewise, in the server 200-3, upon reception of Write 1 by a corresponding APP 205, a processing unit 206 executes the process corresponding to Write 1 (S23) and generates the Data 1 as the processing result.

The terminal device 100-3 transmits Read 1 to the server 200-3 (S24).

Upon reception of Read 1 by the corresponding APP 205, the server 200-3 reads the Data 1 and transmits the Data 1 to the terminal device 100-3.

As described above, in the second method, the write request is transmitted to all the servers 200 and the read request is transmitted to one of the servers 200. The second method is, for example, an active replication method.

### Distribution Method Switching Process

The monitoring server 300 executes a distribution method switching process (S1000). The distribution method switching process S1000 is a process that monitors the load in the communication system 10, selects, in accordance with the load, either the first or second distribution methods, and switches the distribution method between the first and second distribution methods.

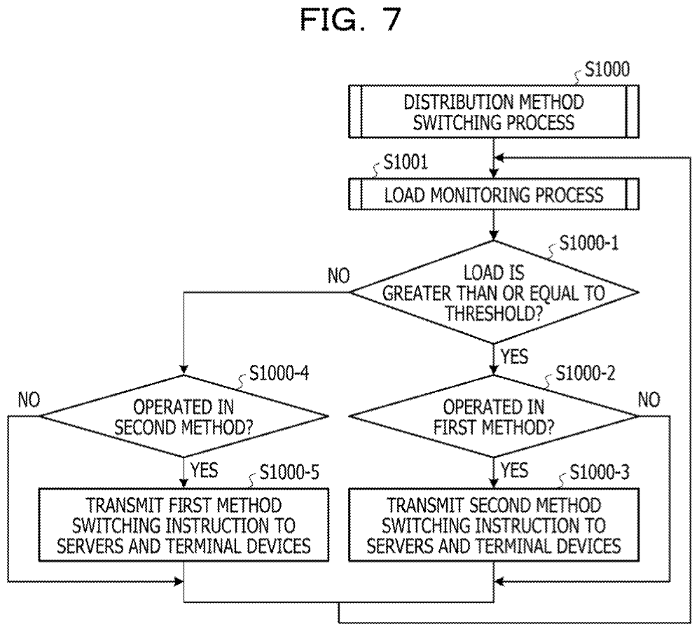

FIG. 7 is a diagram illustrating an example of a process flowchart of the distribution method switching process S1000. The monitoring server 300 executes a load monitoring process (S1001). The load monitoring process S1001 is a process that monitors (measures) the load in the communication system 10. A process flowchart of the load monitoring process S1001 will be described later.

The monitoring server 300 determines whether the load is greater than or equal to a threshold (a first threshold, a second threshold) (S1000-4 When the load is greater than or equal to the threshold (Yes in S1000-1), in the case where the method in operation is the first method (Yes in S1000-2), the monitoring server 300 transmits the second method switching instruction to the servers 200 and the terminal devices 100 (S1000-3) and executes the load monitoring process S1001 again. In the case where the method in operation is the second method (No in S1000-2), the monitoring server 300 does not transmit the second method switching instruction and executes the load monitoring process S1001 again.

In contrast, when the load is not greater than or equal to the threshold (No in S1000-1), in the case where the method in operation is the second method (Yes in S1000-4), the monitoring server 300 transmits the first method switching instruction to the servers 200 and the terminal devices 100 (S1000-5) and executes the load monitoring process S1001 again. In the case where the method in operation is the first method (No in S1000-4), the monitoring server 300 does not transmit the first method switching instruction and executes the load monitoring process S1001 again.

In this way, the monitoring server 300 switches the distribution method between the first method and the second method in accordance with the load.

### Load Monitoring Process

The monitoring server 300 measures (monitors) the load. The load to be measured is, for example, a request reception number that indicates the number of reception of requests in the servers 200.

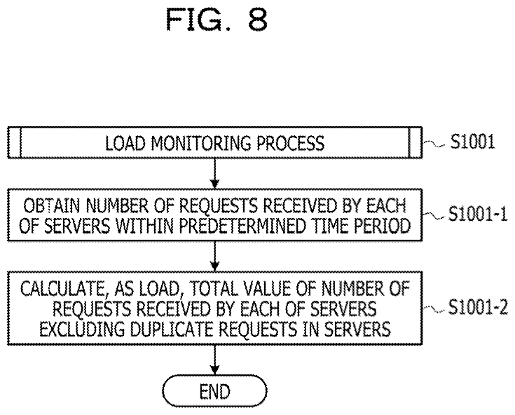

FIG. 8 is a diagram illustrating an example of a process flowchart of the load monitoring process S1001. The monitoring server 300 obtains the number of requests received by each of the servers 200 within a predetermined time period (S1001-1). For example, the monitoring server 300 causes each of the servers 200 to report the number of received requests within the predetermined time period, thereby obtaining the number of requests received by each of the servers 200. Alternatively, for example, the monitoring server 300 may monitor the destination or content of communication packets over the network and count the number of received requests for each of the servers 200.

The monitoring server 300 calculates a total value of the numbers of requests received by the servers 200 as the load (S1001-2) and ends the process. In the calculation of the total value, duplicate requests between the servers are excluded not to be redundantly counted. The duplicate requests refer to transmission of a single write request to all the servers in the second method, and the write requests in the second method are counted as a single request not to be counted as many times as the number of servers.

For example, the load measured in the load monitoring process S1001 is the total value of the number of requests (in the case of the write requests in the second method, the number of the write requests counted as a single request) transmitted by the terminal devices 100. It is regarded that, as the total value increases, the load on the servers 200 increases.

### Switching Process to the First Method

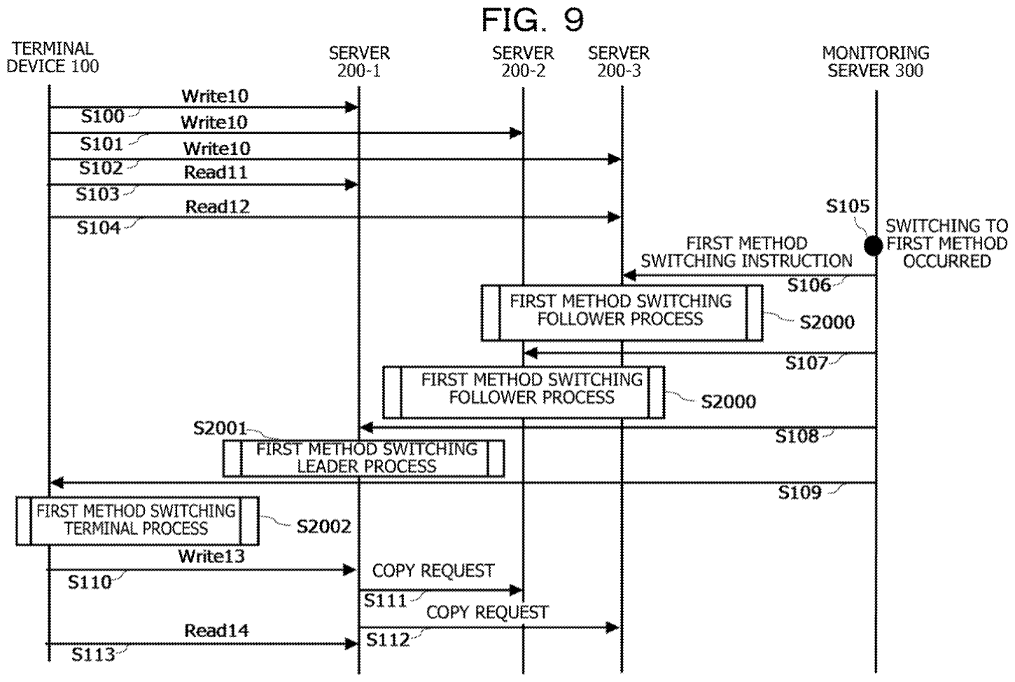

FIG. 9 is a diagram illustrating an example of a sequence of a switching process to the first method. The terminal device 100 in FIG. 9 may be any one of the terminal devices 100-1 to 100-3.

In the communication system 10, the distribution process of the second method is operated. The terminal device 100 transmits Write 10 to the servers 200-1 to 200-3 (S100 to S102). Next, the terminal device 100 transmits Read 11 to the server 200-1 (S103). The terminal device 100 also transmits Read 12 to the server 200-3 (S104).

In the monitoring server 300, a trigger for switching to the first method is generated in the distribution method switching process S1000 (S105, Yes in S1000-4 in FIG. 7). The monitoring server 300 transmits the first method switching instruction to the servers 200-1 to 200-3 and the terminal device 100 (S106 to S109).

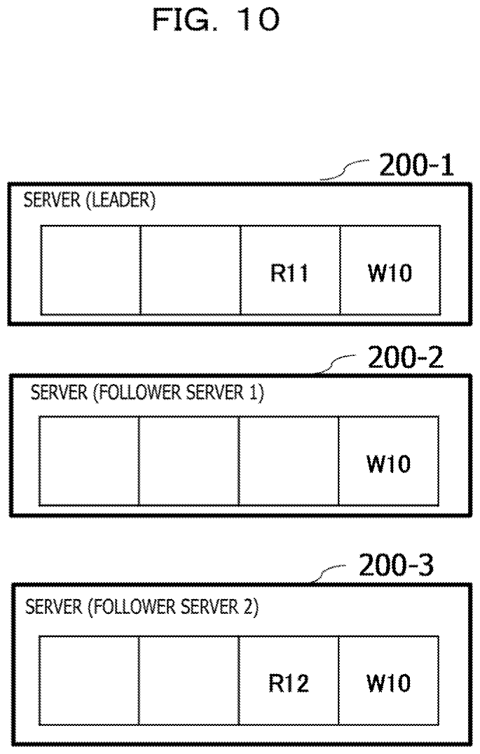

FIG. 10 is a diagram illustrating examples of message queues of the servers 200-1 to 200-3 at the timing of switching to the first method. The older requests are received, the more to the right they are placed in each of the message queues. The servers 200 sequentially process the placed requests from the right in the message queue. In FIG. 10, “W” indicates the write request, and “R” indicates the read request. Write 10 and Read 11 are placed in the message queue of the server 200-1. Write 10 is placed in the message queue of the server 200-2. Write 10 and Read 12 are placed in the message queue of the server 200-3.

Upon reception of the first method switching instruction, the servers 200-2 and 200-3 execute the first method switching follower process (S2000). Whether each of the servers 200 operates as the leader server or the follower server in the first method follows, for example, an instruction from the monitoring server 300 or preset content.

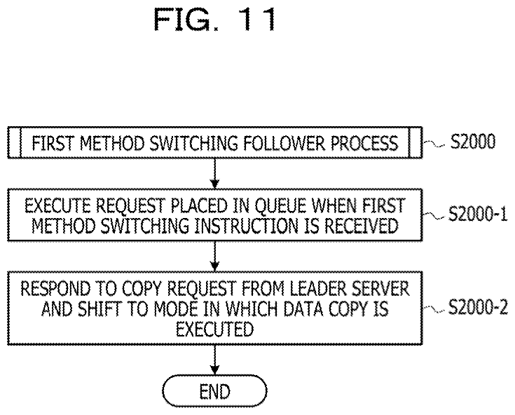

FIG. 11 is a diagram illustrating an example of a process flowchart of the first method switching follower process S2000. In the first method switching follower process S2000, when the first method switching instruction is received, the servers 200 execute the requests placed in the message queues (S2000-1).

The servers 200 shift to a mode in which a copy request from the leader server is executed (S2000-2), and then end the process. After the first method switching follower process S2000 has been ended, the servers 200 operate as the follower servers in the first method.

Referring back to the sequence in FIG. 9, the server 200-3 executes the first method switching follower process S2000. The server 200-3 sequentially executes Write 10 and Read 12 placed in the message queue. The server 200-2 executes first method switching follower process S2000. The server 200-2 executes Write 10 placed in the message queue.

Upon reception of the first method switching instruction, the server 200-1 executes the first method switching leader process (S2001).

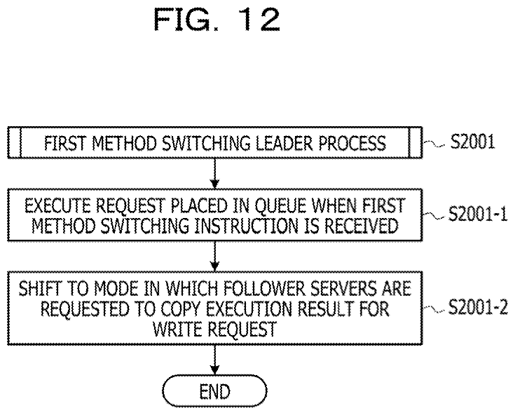

FIG. 12 is a diagram illustrating an example of a process flowchart of the first method switching leader process S2001. In the first method switching leader process S2001, the server 200 executes the requests placed in the message queue when the first method switching instruction is received (S2001-1).

The server 200 shifts to a mode in which the result of executing the write request is copied (copy request is transmitted) to the follower servers 200 (S2001-2), and then ends the process. After the first method switching leader process S2001 has been ended, the server 200 operates as the leader server in the first method.

Referring back to the sequence in FIG. 9, the server 200-1 executes the first method switching leader process S2001. The server 200-1 sequentially executes Write 10 and Read 11 placed in the message queue.

Upon reception of the first method switching instruction, the terminal device 100 executes the first method switching terminal process (S2002).

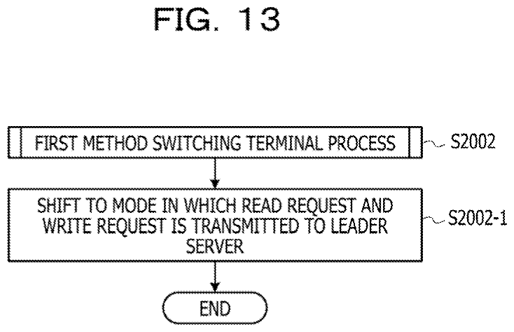

FIG. 13 is a diagram illustrating an example of a process flowchart of the first method switching terminal process S2002. In the first method switching terminal process S2002, the terminal device 100 shifts to a mode in which the read request and the write request are transmitted to the leader server (S2002-1), and then ends the process. After the first method switching terminal process S2002 has been ended, the terminal device 100 operates as the terminal device in the first method.

Referring back to the sequence in FIG. 9, the terminal device 100 operates as the terminal device in the first method. The terminal device 100 transmits Write 13 to the leader server 200-1.

Since the server 200-1 is the leader server, when the process for the write request is executed, the server 200-1 transmits the copy request that is a request for copying the execution result to the follower servers (the servers 200-2 and 200-3) (S111, S112).

The servers 200-2 and 200-3 are in a mode in which the servers 200-2 and 200-3 execute copy requests, and execute copying of the execution results in response to the received copy requests.

### Switching Process to the Second Method

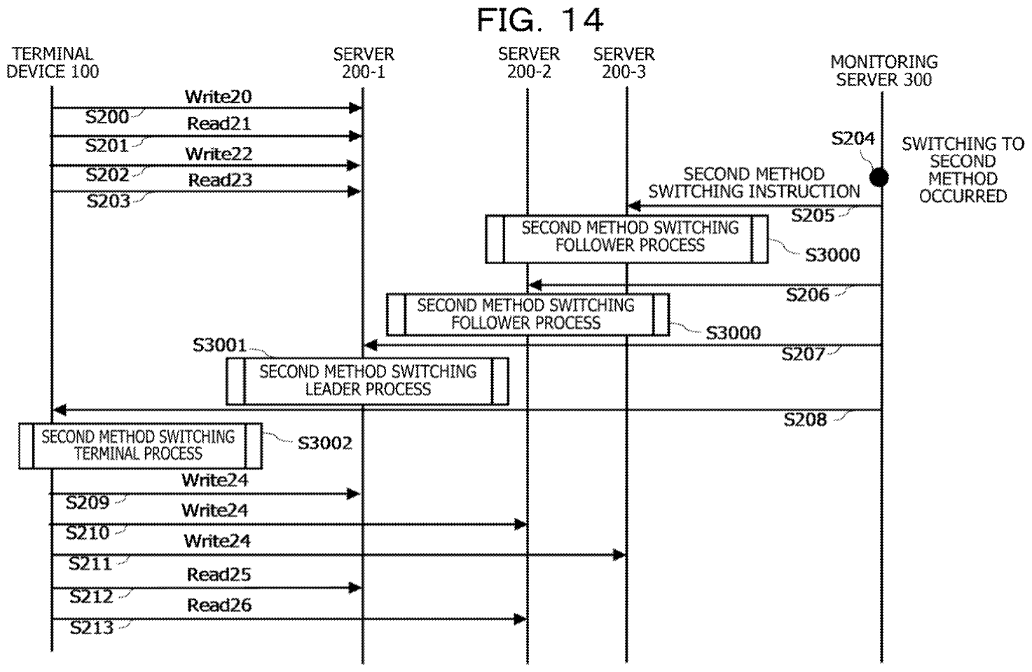

FIG. 14 is a diagram illustrating an example of a sequence of a switching process to the second method. The terminal device 100 in FIG. 14 may be any one of the terminal devices 100-1 to 100-3.

In the communication system 10, the distribution process of the first method is operated. The terminal device 100 transmits Write 20, Read 21, Write 22, Read 23 to the leader server 200-1 (S200 to 203).

In the monitoring server 300, a trigger for switching to the second method is generated in the distribution method switching process S1000 (S204, Yes in S1000-2 in FIG. 7). The monitoring server 300 transmits the second method switching instruction to the servers 200-1 to 200-3 and the terminal device 100 (S205 to S208).

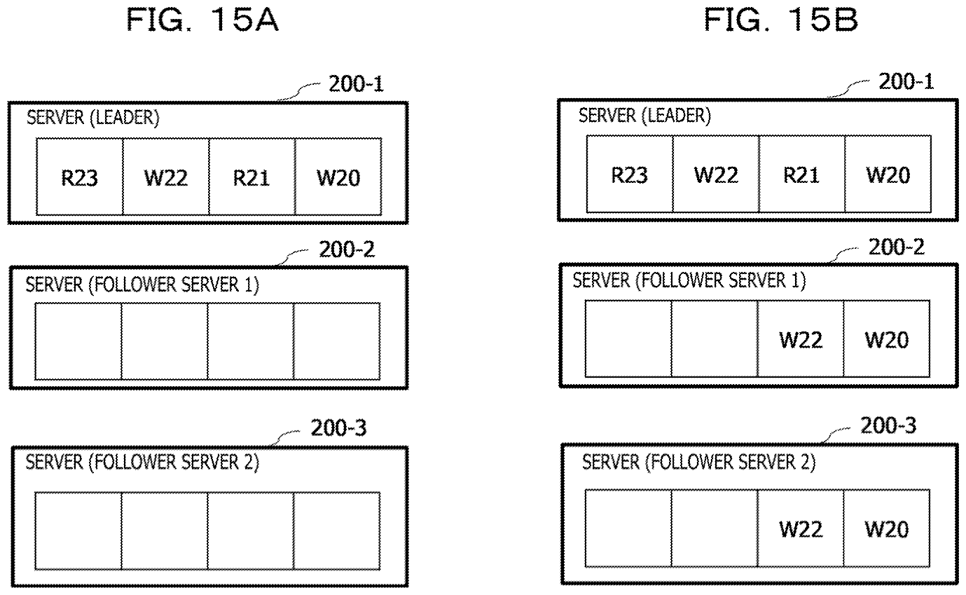

FIGS. 15A and 15B are diagrams illustrating examples of the message queues of the servers 200-1 to 200-3 at the timing of switching to the second method and after switching to the second method, respectively.

FIG. 15A is a diagram illustrating examples of the message queues of the servers 200-1 to 200-3 at the timing of switching to the second method. Write 20, Read 21, Write 22, and Read 23 are placed in the message queue of the server 200-1. No request is placed in the message queue of the server 200-2 or 200-3.

Upon reception of the second method switching instruction, the servers 200-2 and 200-3 execute the second method switching follower process (S3000).

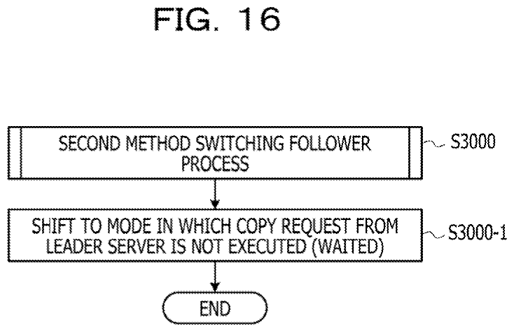

FIG. 16 is a diagram illustrating an example of a process flowchart of the second method switching follower process S3000. In the second method switching follower process S3000, the servers 200 shift to a mode in which the servers 200 do not execute the copy request (wait) (S3000-1), and then end the process. The reason for shifting to the mode in which the servers 200 do not execute the copy request (wait) is that, even when the servers 200 receive the copy request from the leader server 200 that has been switched to the first method in advance at the time of switching to the first method, the servers 200 do not immediately perform the copying (not to perform the copying until the execution of process S2000-1 in FIG. 11 is completed). After the second method switching follower process S3000 has been ended, the servers 200 operate as the servers in the second method.

Referring back to the sequence in FIG. 14, the server 200-3 executes the second method switching follower process S3000. The server 200-2 executes the second method switching follower process S3000.

Upon reception of the second method switching instruction, the server 200-1 executes the second method switching leader process (S3001).

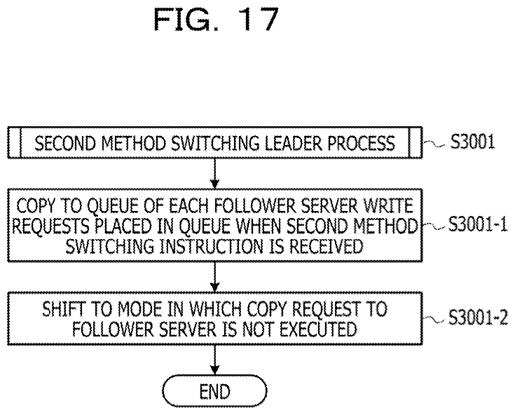

FIG. 17 is a diagram illustrating an example of a process flowchart of the second method switching leader process S3001. In the second method switching leader process S3001, the server 200 copies the write requests placed in the message queue to the message queue of each of the follower servers when the second method switching instruction is received (S3001-1).

The server 200 shifts to a mode in which the server 200 does not transmit the copy request to the follower servers (S3001-2), and then ends the process. After the second method switching leader process S3001 has been ended, the server 200 operates as the server in the second method.

Referring back to the sequence in FIG. 14, the server 200-1 executes the second method switching leader process S3001. The server 200-1 copies Write 20 and Write 22 placed in its own message queue to the message queues of the servers 200-2 and 200-3.

FIG. 15B is a diagram illustrating examples of the message queues of the servers 200-1 to 200-3 after switching to the second method. Write 20 and Write 22 are placed in the message queues of the servers 200-2 and 200-3.

Referring back to the sequence in FIG. 14, upon reception of the second method switching instruction, the terminal device 100 executes the second method switching terminal process (S3002).

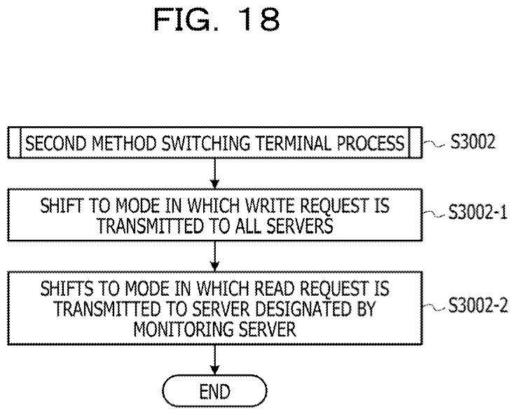

FIG. 18 is a diagram illustrating an example of a process flowchart of the second method switching terminal process S3002. In the second method switching terminal process S3002, the terminal device 100 shifts to a mode in which the write request is transmitted to all the server (S3002-1). The terminal device 100 shifts to a mode in which the terminal device 100 transmits the read request to the server 200 designated by the monitoring server 300 (S3002-2), and then ends the processing. After the second method switching terminal process S3002 has been ended, the terminal device 100 operates as the terminal device in the second method.

Referring back to the sequence in FIG. 14, the terminal device 100 operates as the terminal device in the second method. The terminal device 100 transmits Write 24 to the servers 200-1 to 200-3 (S209 to S211). The process corresponding to Write 24 is executed by all the servers 200-1 to 200-3.

Read 25 is transmitted to the server 200-1 (S212), and Read 26 is transmitted to the server 200-2 (S213). The read requests are distributed by the monitoring server 300 so as not to be gathered in one of the servers.

According to the first embodiment, the monitoring server 300 monitors the load in the communication system 10, and differently uses the first method and the second method in accordance with the load. In this way, the first method and the second method may be differently used such that, for example, the second method is used in the case where the number of requests is great and the first method is used in the case where the load is low. Accordingly, an increase in response time period may be suppressed.

### Other Embodiments

The load measured (monitored) by the monitoring server 300 may be other than the number of requests measured according to the first embodiment. For example, the monitoring server 300 may measure, as the load, an average value of response time periods in the terminal devices 100. When the response time period is used as the load, the monitoring server 300 uses the second method in the case where the response time period is greater than or equal to a threshold and uses the first method otherwise. The load may be, for another example, the usage ratio of the CPUs included in the servers 200. The monitoring server 300 switches the method to the second method in the case where, in the first method, the usage ratio of the CPU of the leader server is higher than or equal to a threshold. The monitoring server 300 switches the method to the first method in the case where, in the second method, an average value of the usage ratios of the CPUs of the servers is lower than a threshold.

The thresholds for switching between the first method and the second method are not necessarily the same. For example, when a first threshold for switching from the first method to the second method is set to be larger than a second threshold for switching from the second method to the first method, the occurrences of frequent switching of the method may be suppressed.

When a period of time appointed for actually switching the method is included in the method switching instruction, the method may be simultaneously switched for each of the servers and each of the terminal devices.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A monitoring system comprising:
a plurality of terminal devices;
a plurality of execution servers configured to execute requests received from the terminal devices; and
a monitoring server, wherein
the plurality of execution servers each operate as a leader server or a follower server in a first distribution method, wherein
the first distribution method or a second distribution method is able to be executed, wherein
in the first distribution method, the plurality of terminal devices transmit all read requests and all write requests to the leader server and the leader server executes execution result copying in which results of execution of the write requests are copied to the follower server, and
in the second distribution method, the plurality of terminal devices transmit the write requests to all the plurality of execution servers and transmit the read requests to one of the plurality of execution servers, and wherein
the monitoring server includes a processor configured to:
cause the plurality of terminal devices and the plurality of execution servers to execute the first distribution method,
cause the plurality of terminal devices and the plurality of execution servers to execute the second distribution method,
monitor a load of the plurality of execution servers,
select one of the first distribution method and the second distribution method in accordance with the load, and
instruct the plurality of terminal devices and the plurality of execution servers to execute the selected distribution method.

2. The monitoring system according to claim 1, wherein
the processor is configured to select the second distribution method in a case where the load is greater than or equal to a first threshold and select the first distribution method in a case where the load is smaller than a second threshold.

3. The monitoring system according to claim 1, wherein
the processor is configured to assign the execution servers that execute the read requests in the second distribution method such that the read requests are not concentrated in a specific one of the execution servers and instruct the plurality of terminal devices the execution servers to which the read requests are to be transmitted.

4. The monitoring system according to claim 1, wherein
the load includes a total value of the write requests and the read requests transmitted from the plurality of terminal devices to the plurality of execution servers.

5. The monitoring system according to claim 1, wherein
the load includes an average value of response time periods from transmission of the read requests and the write requests by the plurality of terminal devices to reception of results by the plurality of terminal devices.

6. The monitoring system according to claim 1, wherein,
when switching to the second distribution method is performed, the leader server executes request copying in which the write requests that have been placed in a message queue of the leader server during execution of the first distribution method and that have not been executed are copied to a message queue of the follower server.

7. The monitoring system according to claim 6, wherein
the leader server stops the execution result copying after the request copying is completed.

8. The monitoring system according to claim 1, wherein,
when switching to the first distribution method is performed, the leader server and the follower server execute the write requests that have been placed in message queues of the leader server and the follower server during execution of the second distribution method and that have not been executed and the read requests that have been placed in the message queues of the leader server and the follower server during execution of the second distribution method and that have not been executed.

9. The monitoring system according to claim 8, wherein
the leader server starts the execution result copying after completion of execution of the write requests that have not been executed and the read requests that have not been executed.

10. The monitoring system according to claim 9, wherein,
when switching to the first distribution method is performed, the follower server starts the execution result copying by the leader server after the completion of the execution of the write requests that have not been executed and the read requests that have not been executed.

11. The monitoring system according to claim 1, wherein
the read requests are messages that request reading of data and notifying the terminal devices of the read data, and wherein
the write requests are messages that request the servers to perform predetermined processes.

12. The monitoring system according to claim 1, wherein
the first distribution method includes a passive replication method, and
the second distribution method includes an active replication method.

13. A non-transitory computer-readable recording medium having stored therein a program for causing a monitoring server to execute a process for monitoring, wherein
a monitoring system includes a plurality of terminal devices, a plurality of execution servers configured to execute requests received from the terminal devices, and the monitoring server, wherein
the plurality of execution servers each operate as a leader server or a follower server in a first distribution method, wherein
the monitoring system is able to execute the first distribution method or a second distribution method, wherein
in the first distribution method, the plurality of terminal devices transmit all read requests and all write requests to the leader server and the leader server executes execution result copying in which results of execution of the write requests are copied to the follower server, and
in the second distribution method, the plurality of terminal devices transmit the write requests to all the plurality of execution servers and transmit the read requests to one of the plurality of execution servers, and wherein
the process for monitoring includes
a first control process that causes the plurality of terminal devices and the plurality of execution servers to execute the first distribution method,
a second control process that causes the plurality of terminal devices and the plurality of execution servers to execute the second distribution method,
a monitoring process that monitors a load of the plurality of execution servers, and
a switching process that selects one of the first distribution method and the second distribution method in accordance with the load and executes the first control process or the second control process.

14. A non-transitory computer-readable recording medium having stored therein a program for causing a leader server to execute processes to be monitored, wherein
the leader server executes the processes in a monitoring system that includes a plurality of terminal devices, a plurality of execution servers configured to execute requests received from the terminal devices, and a monitoring server, wherein
a first distribution method or a second distribution method are able to be executed, wherein
in the first distribution method, the plurality of terminal devices transmit all read requests and all write requests to the leader server and the leader server executes execution result copying in which results of execution of the write requests are copied to a follower server, and
in the second distribution method, the plurality of terminal devices transmit the write requests to all the plurality of execution servers and transmit the read requests to one of the plurality of execution servers, wherein
the plurality of execution servers each operate as the leader server or the follower server in the first distribution method in the monitoring system, and wherein
the leader server executes
a first process in which the leader server executes the read requests and the write requests and copies the results of the execution of the write requests to the follower server in the first distribution method,
a second process in which the leader server executes the read requests and the write requests in the second distribution method, and
a switching process in which the leader server executes the first process or the second process by following an instruction on performing of the first distribution method and the second distribution method switching to which is performed in accordance with a load of the plurality of servers monitored by the monitoring server.
